(19) United States
(12) Patent Application Publication
(10) Pub. No.: US 2019/0300311 A1
(43) Pub. Date: Oct. 3, 2019

(54) PAPER SHEET HANDLING APPARATUS AND METHOD FOR DETECTING FOREIGN OBJECT

(71) Applicant: FUJITSU FRONTECH LIMITED, Tokyo (JP)

(72) Inventors: Makoto TAKAYAMA, Inagi (JP); Daiki HARAI, Inagi (JP); Ryo FUJIWARA, Inagi (JP); Hiroshi YANAGIDA, Inagi (JP); Koichi HOSOYAMA, Inagi (JP)

(73) Assignee: FUJITSU FRONTECH LIMITED, Tokyo (JP)

(21) Appl. No.: 16/441,783

(22) Filed: Jun. 14, 2019

Related U.S. Application Data
(63) Continuation of application No. PCT/JP2016/088540, filed on Dec. 22, 2016.

(51) Int. Cl. B65H 7/06; B65H 5/06; G07D 11/14; G07D 11/22; G07D 11/16

(52) U.S. Cl. CPC B65H 7/06; B65H 5/062; G07D 11/14; G07D 11/22; G07D 11/12; B65H 2511/13; B65H 2701/1912; G07D 2211/00; G07D 11/16

(57) ABSTRACT

A paper sheet handling apparatus includes an insertion slot to which a banknote is inserted, a conveyor mechanism that conveys the paper sheet inserted through an insertion slot, and a corrective member that has an elastic deformation portion designed to contact the paper sheet inserted to the insertion slot and corrects a direction of conveyance of the paper sheet inserted through the insertion slot using the elasticity of the elastic deformation portion. The corrective member is disposed at least on both ends in the width direction of the insertion slot, along a face of the banknote inserted to the insertion slot, or at positions, on a conveyor line for the paper sheet inserted through the insertion slot, facing the ends in the width direction of the insertion slot.

### CROSS-REFERENCE TO RELATED APPLICATION

This application is a continuation application of International Application PCT/JP2016/088540, filed on Dec. 22, 2016 and designating the U.S., the entire contents of which are incorporated herein by reference.

### FIELD

The present invention relates to a paper sheet handling apparatus and a method for detecting a foreign object.

### BACKGROUND

For example, an automated teller machine (hereinafter referred to as an ATM) includes a banknote handling apparatus that handles banknotes as a type of paper sheet. A well-known banknote handling apparatus has a deposit and withdrawal unit with an insertion slot, to which banknotes are inserted along the horizontal direction. A banknote inserted through the insertion slot of the deposit and withdrawal unit, is fed into the deposit and withdrawal unit by a conveyor mechanism and is taken in the deposit and withdrawal unit.

Patent Literature 1: Japanese Laid-open Patent Publication No. 2005-259086

The insertion slot has a width, along a face of a banknote inserted to the insertion slot, designed to receive the largest banknote among banknotes handled by the deposit and withdrawal unit with the intention to handle a plurality of types of banknotes in different sizes. This structure sometimes causes a comparatively small banknote to be inserted in a manner to be shifted to one side in the width direction of the insertion slot, or causes a direction of insertion of the banknote to be slanted toward one side in the width direction of the insertion slot. If, for example, stacked banknotes are not aligned in the same direction for inserting into the insertion slot, the banknotes are inserted with some banknotes slanted with respect to the insertion direction. Such improper insertion of banknotes may slant the direction in which the conveyor mechanism conveys the banknotes, and cause paper jams (hereinafter referred to as jams). The banknote jams problematically reduce the reliability of operation of the banknote handling apparatus.

### SUMMARY

According to an aspect of the embodiments, a paper sheet handling apparatus includes: an insertion slot to which a paper sheet is inserted; a conveyor mechanism that conveys the paper sheet inserted through the insertion slot; and a corrective member which includes an elastic deformation portion configured to contact the paper sheet inserted to the insertion slot and which corrects a direction of conveyance of the paper sheet inserted through the insertion slot using elasticity of the elastic deformation portion, wherein the corrective member is disposed at least on both ends in a width direction of the insertion slot, along a face of the paper sheet inserted to the insertion slot, or at positions, on a conveyor line for the paper sheet inserted through the insertion slot, facing the ends in the width direction of the insertion slot.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic view of a banknote handling apparatus of an embodiment.

FIG. 2 is a perspective view of a deposit and withdrawal unit of the banknote handling apparatus of the embodiment.

FIG. 3 is a front view of the deposit and withdrawal unit of the banknote handling apparatus of the embodiment.

FIG. 4 is a plane view of a deposit and withdrawal mechanism included in the deposit and withdrawal unit of the banknote handling apparatus of the embodiment.

FIG. 5 is a side sectional view of the deposit and withdrawal mechanism included in the deposit and withdrawal unit of the banknote handling apparatus of the embodiment.

FIG. 6 is a plane view to explain action of a corrective member of the embodiment to correct a direction in which a banknote is conveyed.

FIG. 7 is a front view to explain an elastic deformation portion included in a corrective member of a first modification.

FIG. 8 is a front view to explain a corrective member of a second modification.

FIG. 9 is a plane view to explain the corrective member of the second modification.

FIG. 10 is a front view to explain a corrective member of a third modification.

FIG. 11 is a schematic front view of a corrective member of a fourth modification.

FIG. 12 is a front view of a banknote handling apparatus of a fifth modification.

FIG. 13 is a flowchart to explain processing of detecting a foreign object performed by a banknote handling apparatus of the fifth modification.

### DESCRIPTION OF EMBODIMENTS

Embodiments of a paper sheet handling apparatus and a method for detecting a foreign object of the present invention will now be described with reference to the drawings. Note that the embodiments are not intended to limit the paper sheet handling apparatus and the method for detecting a foreign object of the present invention.

### Embodiments

### Configuration of Banknote Handling Apparatus

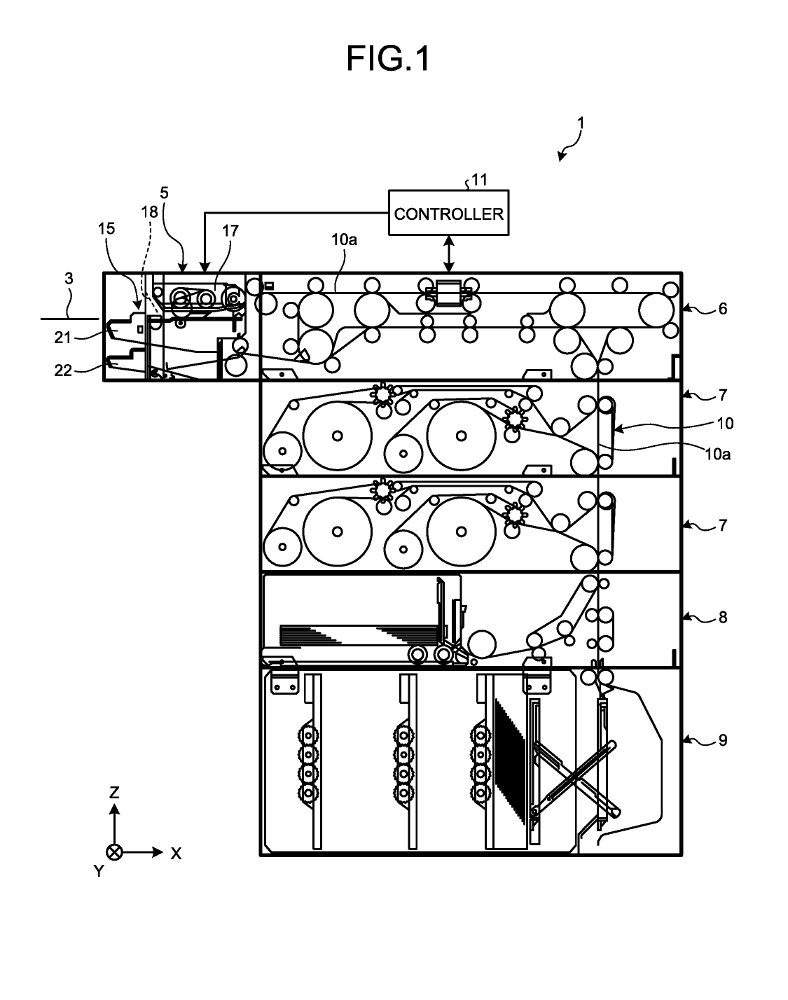

FIG. 1 is a schematic view of a banknote handling apparatus of an embodiment. As illustrated in FIG. 1, a banknote handling apparatus 1 of the embodiment includes a deposit and withdrawal unit 5 to deposit and withdraw a banknote 3, a validation unit 6 to validate the banknote 3, a plurality of retention units 7 to temporarily accommodating the banknote 3, a withdrawal banknote accommodation unit 8 in which banknotes for withdrawal are refilled and accommodated, and a storage 9 to store the banknote 3. The banknote handling apparatus 1 further includes a conveyor mechanism 10, which has a conveyor line 10a that connects between the deposit and withdrawal unit 5, the validation unit 6, the retention units 7, the withdrawal banknote accommodation unit 8, and the storage 9 and conveys the banknote 3, and a controller 11 to control the conveyor mechanism 10.

The number of the retention units 7 in the banknote handling apparatus 1 is not limited to be more than one. At least one retention unit 7 and the storage 9 are needed to configure the banknote handling apparatus 1. The controller 11 controls each of the deposit and withdrawal unit 5, the validation unit 6, the retention unit 7, the withdrawal banknote accommodation unit 8, the storage 9, and the conveyor mechanism 10. For convenience of description, as an exemplary posture of the banknote handling apparatus 1 illustrated in FIG. 1 and the subsequent drawings, the front to rear direction (the depth direction) of the banknote handling apparatus 1 in FIG. 1 will be indicated as an X-direction, the right to left direction (the width direction) of the banknote handling apparatus 1 will be indicated as a Y-direction, and the vertical direction (the height direction) of the banknote handling apparatus 1 will be indicated as a Z-direction, with a side having the deposit and withdrawal unit 5 defined as a front side (face side). In the banknote handling apparatus 1, the X-, Y-, Z-directions are not limited to the front to rear direction, the right to left direction, and the vertical direction, respectively.

The banknote 3 fed into the banknote handling apparatus 1 by the deposit and withdrawal unit 5 is, for example, conveyed to the retention unit 7 after passing the validation unit 6 validating the banknote 3. The deposit and withdrawal unit 5 in the banknote handling apparatus 1 serves as both a deposit unit and a withdrawal unit. Instead of this configuration, a deposit unit and a withdrawal unit may be separately provided. In this embodiment, the deposit unit and the withdrawal unit are collectively referred to as the deposit and withdrawal unit 5.

Examples of the banknote 3 include a banknote formed of a resin material such as polymer. The banknote handling apparatus 1 of the present invention is described using the banknote 3 as an example of a paper sheet in this embodiment; however, the banknote 3 is not the only example. Examples of the paper sheet include a check, a cash voucher, securities, coupons, and any other valuable media other than the banknote 3.

### Configuration of Deposit and Withdrawal Unit

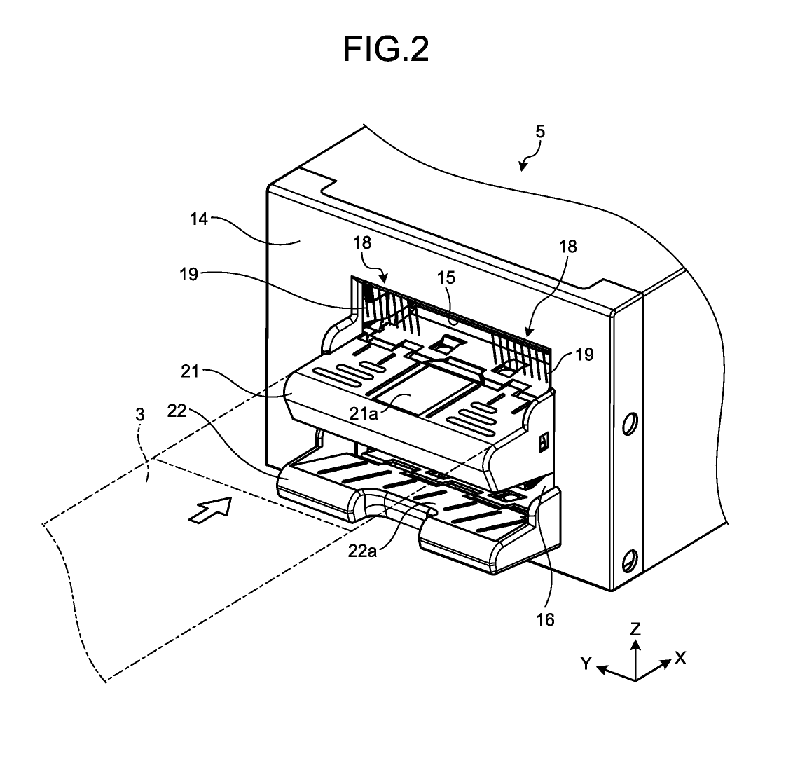

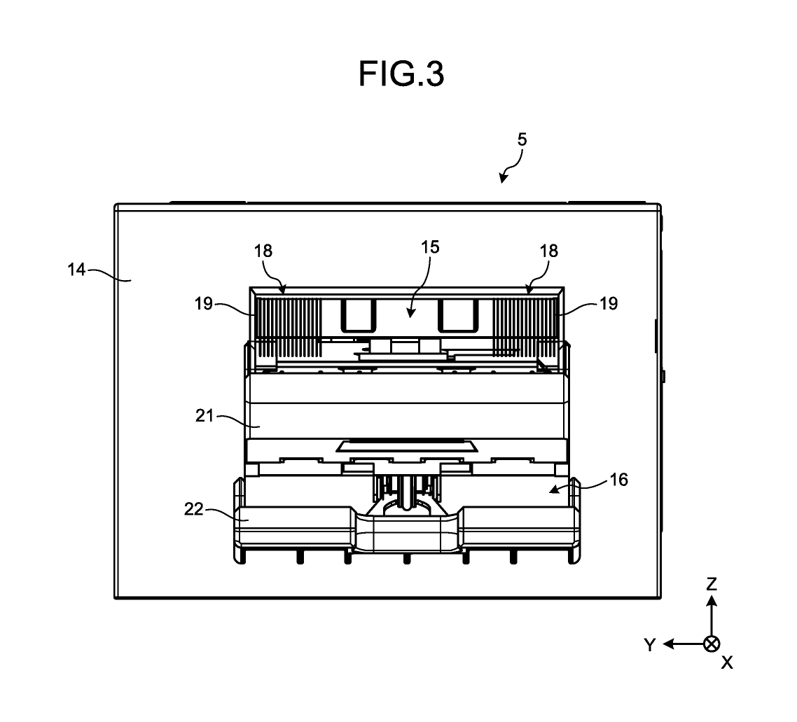

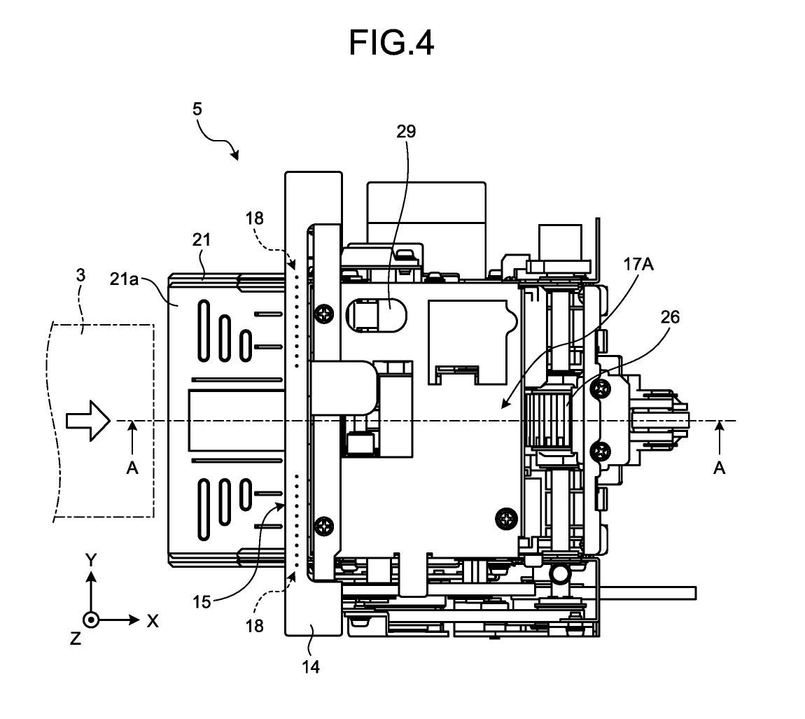

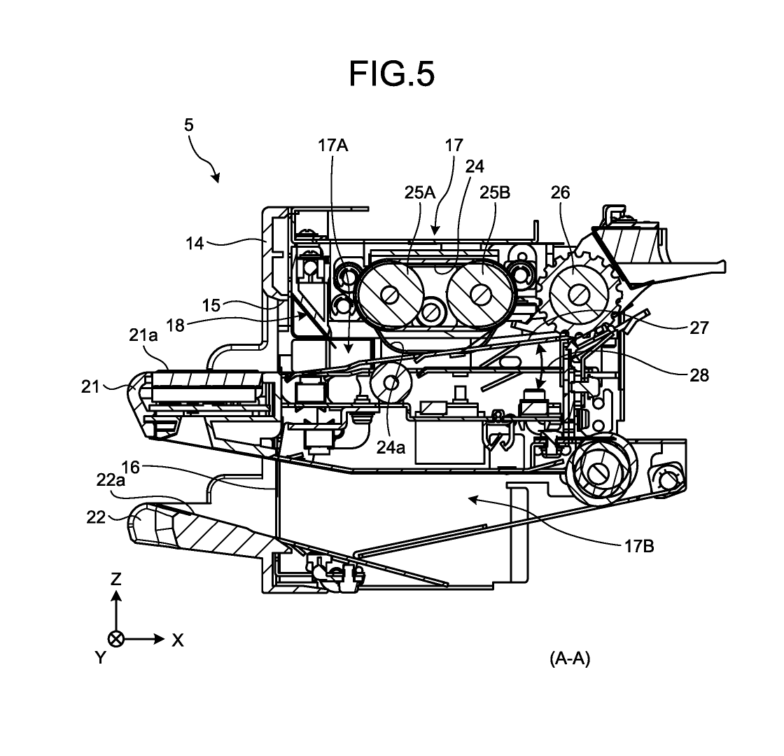

FIG. 2 is a perspective view of the deposit and withdrawal unit 5 of the banknote handling apparatus 1 of the embodiment. FIG. 3 is a front view of the deposit and withdrawal unit 5 of the banknote handling apparatus 1 of the embodiment. FIG. 4 is a plane view of a deposit and withdrawal mechanism included in the deposit and withdrawal unit 5 of the banknote handling apparatus 1 of the embodiment. FIG. 5 is a side sectional view of the deposit and withdrawal mechanism included in the deposit and withdrawal unit 5 of the banknote handling apparatus 1 of the embodiment, and is a sectional view along A-A line in FIG. 4.

As illustrated in FIG. 1 and FIG. 2, the deposit and withdrawal unit 5 includes an insertion slot (a deposit slot) 15 to receive the banknote 3, an ejection slot (a withdrawal slot) 16 to eject the banknote 3, a deposit and withdrawal mechanism 17 serving as a conveyor mechanism that conveys the banknote 3 inserted to the insertion slot 15 and conveys the banknote 3 to the ejection slot 16, and a corrective member 18 to correct a direction of conveyance of the banknote 3 inserted through the insertion slot 15.

As illustrated in FIG. 2 and FIG. 3, the insertion slot 15 is rectangular having the width direction (the Y-direction) of the insertion slot 15 along a face of the banknote 3 inserted to the insertion slot 15 as its long side and the vertical direction (the Z-direction) of the insertion slot 15, that is, the direction of thickness of the banknote 3 inserted to the insertion slot 15, as its short side. The ejection slot 16 is formed below the insertion slot 15 and is rectangular as with the insertion slot 15. In this embodiment, a rectangular banknote 3 is inserted to the insertion slot 15 from an end of the long side of the banknote 3 along the long side of the banknote 3 with the short side of the banknote 3 arranged parallel to the width direction of the insertion slot 15. In this embodiment, the banknote 3 is inserted to the insertion slot 15 with the short side first. In another manner, the banknote 3 may be inserted to the insertion slot 15 with the long side first.

As illustrated in FIG. 2, the insertion slot 15 and the ejection slot 16 are aligned in the vertical direction (the Z-direction) of a front panel 14 of the deposit and withdrawal unit 5 with a certain space disposed therebetween. The front panel 14 has a deposit tray 21 projecting from a lower end of the insertion slot 15 along the X-direction and configured to mount the banknote 3 inserted through the insertion slot 15. Likewise, the front panel 14 has a withdrawal tray 22 projecting from a lower end of the ejection slot 16 along the X-direction and configured to mount the banknote 3 ejected from the ejection slot 16. The deposit tray 21 has a mounting surface 21a to mount the banknote 3, arranged over the length in the width direction (the Y-direction) of the insertion slot 15. Likewise, the withdrawal tray 22 has a mounting surface 22a to mount the banknote 3, arranged over the length in the width direction of the ejection slot 16.

As illustrated in FIG. 5, the deposit and withdrawal mechanism 17 of the deposit and withdrawal unit 5 has a deposit conveyor line 17A to convey the banknote 3 from the insertion slot 15 and a withdrawal conveyor line 17B to convey the banknote 3 to the ejection slot 16. The deposit conveyor line 17A is continuous from the mounting surface 21a of the deposit tray 21. The withdrawal conveyor line 17B is continuous to the mounting surface 22a of the withdrawal tray 22 of the ejection slot 16.

The deposit and withdrawal mechanism 17 is connected with the controller 11. As illustrated in FIG. 4 and FIG. 5, the deposit and withdrawal mechanism 17 includes a conveyor belt 24 to convey the banknote 3, a first pulley 25A and a second pulley 25B to drive the conveyor belt 24, and a reel out roller 26 to separate stacked banknotes 3 and send one by one. The deposit and withdrawal mechanism 17 further includes a guiding plate 27 to guide the banknote 3 conveyed by the conveyor belt 24 and a pressing plate 28 to press the banknote 3 toward the conveyor belt 24 and hold the banknote 3 in between the guiding plate 27 and the pressing plate 28.

The conveyor belt 24 is suspended over the first pulley 25A and the second pulley 25B while being warped by its own weight. The rotating conveyor belt 24 conveys the banknote 3 using a warped portion 24a of the conveyor belt 24, more specifically, by having the warped portion 24a contact the banknote 3. This manner limits the magnitude of conveyance power transmitted from the rotating conveyor belt 24 to the banknote 3, and thus can avoid excessive conveyance power from being applied to the banknote 3. This configuration allows the deposit and withdrawal mechanism 17 to properly cause only the uppermost banknote 3 (the upper end in the Z-direction) of stacked banknotes 3, which are inserted through the insertion slot 15, to be taken in toward the reel out roller 26.

The guiding plate 27 is disposed above the deposit conveyor line 17A, along the warped portion 24a of the conveyor belt 24. The pressing plate 28 is elevatable in the Z-direction with an elevator mechanism (not illustrated). As illustrated in FIG. 4, the deposit conveyor line 17A has a location sensor 29, which senses entry of the banknote 3 inserted through the insertion slot 15, located at a position facing a face of the banknote 3 conveyed along the deposit conveyor line 17A.

### Configuration of Corrective Member

As illustrated in FIG. 2 and FIG. 3, the corrective member 18 includes, for example, a brush-like elastic deformation portion 19, in other words, the corrective member 18 is formed in a bristle brush. Any material such as resin may be used for the bristles of the elastic deformation portion 19 as long as the elastic deformation portion 19 can achieve desired elasticity. The elastic deformation portion 19 may be formed in an elastic film (paper sheet) or a plastic lever, instead of the bristle brush, as described later in a fifth modification. The elastic deformation portion 19 may be formed in an elastic sponge. Any form of the elastic deformation portion 19 is usable.

The corrective members 18 are disposed at both sides in the width direction (the Y-direction) of the insertion slot 15. All the bristles of the brush-like elastic deformation portion 19 extend, for example, in one direction. The bristle of the elastic deformation portion 19 in this embodiment extends along the vertical direction (the Z-direction) of the insertion slot 15, and, as illustrated in FIG. 2 and FIG. 5, extends in a manner to be slanted toward the deposit conveyor line 17A, conveying the banknote 3 inserted through the insertion slot 15, with respect to an opening surface (the YZ-plane) of the insertion slot 15. In other words, each bristle of the elastic deformation portion 19 extends in a manner to be slanted toward the direction of the deposit conveyor line 17A with respect to a thickness direction (the Z-direction) of the banknote 3, on the XZ-plane parallel to an insertion direction (the X-direction) of the banknote 3 inserted to the insertion slot 15 and to the thickness direction (the Z-direction) of the banknote 3 inserted to the insertion slot 15.

When the banknote 3 inserted to the insertion slot 15 contacts the elastic deformation portion 19 of the corrective member 18, the above layout can keep the elastic deformation portion 19 from interfering with the entering banknote 3. More specifically, this layout can reduce the resistance caused by the elastic deformation portion 19 of the corrective member 18 to the banknote 3 entering the insertion slot 15, in other words, reduce generation of force pushing the banknote 3 backward, in the process of inserting the banknote 3 to the insertion slot 15. In this manner, the banknote 3 can be smoothly inserted through the insertion slot 15.

### Banknote Corrective Action by Corrective Member

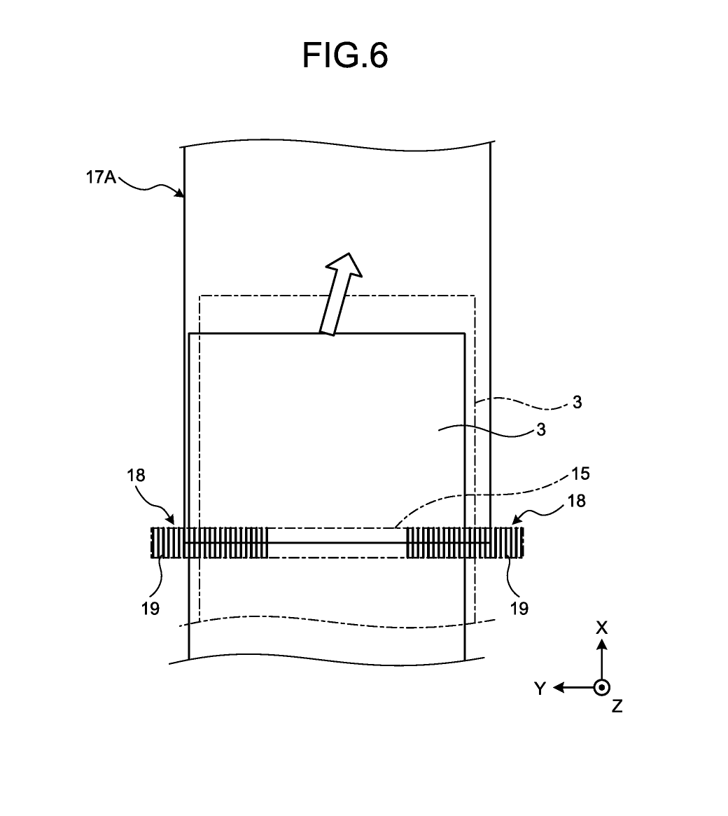

FIG. 6 is a plane view to explain action of the corrective member 18 of the embodiment to correct a direction of conveyance of the banknote 3. As illustrated in FIG. 6, if the banknote 3 is inserted through the insertion slot 15 in a manner to be shifted to one side in the width direction (the Y-direction) of the insertion slot 15, the elastic deformation portion 19 of the corrective member 18 located on the same side in the width direction of the insertion slot 15 moves (bends) in a larger amount than the amount of move of the elastic deformation portion 19 of the corrective member 18 located on the opposite side. In this process, reaction force (pressing force), matching the amount of move of the elastic deformation portion 19, acts on the banknote 3. The elastic deformation portion 19 flips the banknote 3 backward, which changes the position and the direction (the posture) of the banknote 3. The banknote 3 receives respective different amounts of reaction force from the elastic deformation portions 19 of the corrective members 18 located on both sides in the width direction of the insertion slot 15. The difference in the amount of reaction force moves the banknote 3 in the direction of the arrow, toward one of the corrective members 18 applying a smaller amount of reaction force to the banknote 3, in the width direction of the insertion slot 15. This process corrects the position and the direction of the banknote 3 on the deposit conveyor line 17A, and therefore allows the banknote 3 to be properly conveyed along the direction of conveyance.

Moreover, when the banknote 3 is inserted to the insertion slot 15 in a manner to be slanted with respect to the conveyance direction of the deposit conveyor line 17A, reaction force applied to the banknote 3, upon contact with the elastic deformation portions 19 of the corrective members 18 disposed on respective sides in the width direction of the insertion slot 15, corrects the direction of the banknote 3 on the deposit conveyor line 17A and therefore allows the banknote 3 to be conveyed along a proper conveyance direction.

Furthermore, for example, even when stacked banknotes 3 not aligned in the same direction are inserted through the insertion slot 15, the above corrective action of the corrective member 18 allows the stacked banknotes 3 to be aligned along the conveyance direction and to be conveyed along the proper conveyance direction.

The above corrective action is still effective for the banknote 3 not contacting both the corrective members 18 disposed on the respective sides in the width direction (the Y-direction) of the insertion slot 15. For the banknote 3 contacting either one of the corrective members 18 disposed on both sides in the width direction of the insertion slot 15, reaction force applied to the banknote 3 by the elastic deformation portion 19 of the corrective member 18 contacting the banknote 3 moves the banknote 3 toward the other corrective member 18 not in contact with the banknote 3. This process corrects the position and the direction of the banknote 3 on the deposit conveyor line 17A and allows the banknote 3 to be conveyed along the conveyance direction.

As described above, the banknote handling apparatus 1 of the embodiment includes the corrective members 18 to correct the conveyance direction of the banknote 3 inserted through the insertion slot 15 using elasticity of the elastic deformation portions 19. The corrective members 18 are disposed on both sides in the width direction (the Y-direction) of the insertion slot 15. The elastic deformation portion 19 of the corrective member 18 is capable of correcting the position and the direction of the banknote 3 inserted to the insertion slot 15 and therefore allows the banknote 3 to be properly conveyed along the conveyance direction. This configuration can reduce jams of the banknote 3, which consequently prevents a reduction in reliability of operation of the banknote handling apparatus 1 caused due to the jams of the banknote 3.

The elastic deformation portion 19 of the corrective member 18 included in the banknote handling apparatus 1 of the embodiment extends in a slanted manner toward the deposit conveyor line 17A conveying the banknote 3 inserted through the insertion slot 15, with respect to an opening surface of the insertion slot 15. When the banknote 3 inserted to the insertion slot 15 contacts the elastic deformation portion 19 of the corrective member 18, the above layout can reduce the resistance, generated by the elastic deformation portion 19 of the corrective member 18, to the banknote 3 entering the insertion slot 15. In this manner, the banknote 3 can be smoothly inserted to the insertion slot 15.

First to fifth modifications will now be described with reference to the drawings. For convenience, like reference numerals in the first to the fifth modifications indicate like components described in the embodiment, and those components will not be described again.

### First Modification

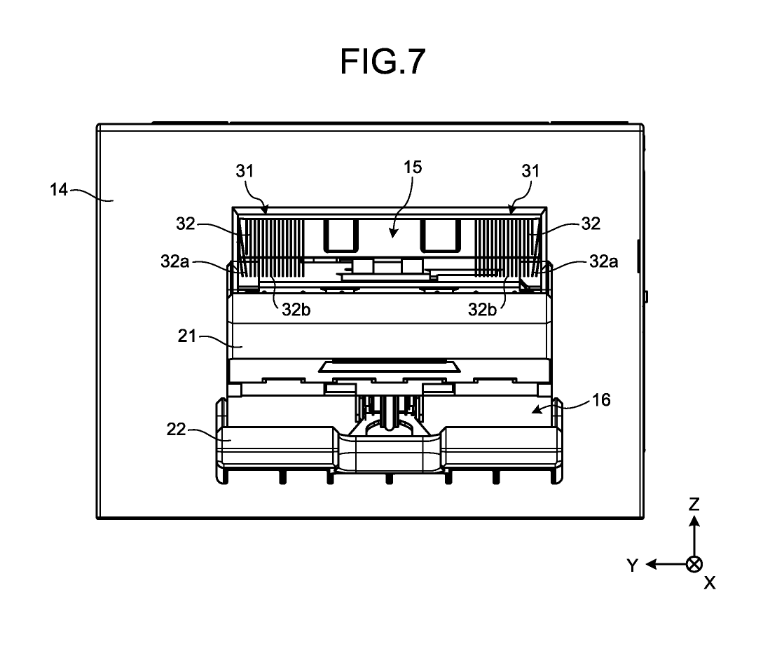

FIG. 7 is a front view to explain an elastic deformation portion included in a corrective member of a first modification. The first modification is different from the embodiment in the direction of extension of bristles of the elastic deformation portion of the corrective member, disposed on each side in the width direction of the insertion slot 15.

As illustrated in FIG. 7, an elastic deformation portion 32 of a corrective member 31 in the first modification has bristles 32a extending in a slanted manner toward the center in the width direction (the Y-direction) of the insertion slot 15, on an opening surface (the YZ-plane) of the insertion slot 15, with respect to the thickness direction (the Z-direction) of the banknote 3 inserted to the insertion slot 15. For example, the elastic deformation portion 32 of the corrective member 31 has bristles 32a, located closer to the ends in the width direction of the insertion slot 15, extending in a slanted manner toward the center of the insertion slot 15 and has bristles 32b, located closer to the center in the width direction of the insertion slot 15, extending in the thickness direction of the banknote 3. The elastic deformation portion 32 therefore has bristles 32a and 32b extending in different directions.

In the first modification, the bristles 32a located closer to the ends in the width direction (the Y-direction) of the insertion slot 15, among bristles of the elastic deformation portion 32, are selectively slanted. Instead of this design, all the bristles may be slanted. As needed to adjust the reaction force acting on the banknote 3, the direction in which the bristles are slanted may be varied along the width direction of the insertion slot 15. The elastic deformation portion 32 may have bristles, located closer to the ends in the width direction of the insertion slot 15, slanted at a larger angle and have other bristles slanted such that the angle of slant becomes smaller toward the center from the ends of the insertion slot 15. This manner can increase the elasticity of bristles located closer to the ends of the insertion slot 15 compared to the bristles located closer to the center of the insertion slot 15. The variations in the elasticity further increase the reaction force acting on the banknote 3 inserted to the insertion slot 15, with an increase in the amount of shift of the banknote 3 to one side in the width direction of the insertion slot 15 and with an increase in the amount of slant of the insertion direction with respect to the conveyance direction of the deposit conveyor line 17A. This configuration can therefore further properly correct the direction of the banknote 3.

In the first modification, the bristles 32a and 32b of the elastic deformation portion 32 are slanted in the above-described manner. In addition to this design, as with the first embodiment, the bristles 32a and 32b may extend in a slanted manner toward the deposit conveyor line 17A with respect to the thickness direction (the Z-direction) of the banknote 3, on the XZ-plane parallel to the insertion direction (the X-direction) of the banknote 3 inserted to the insertion slot 15 and to the thickness direction (the Z-direction) of the banknote 3 inserted to the insertion slot 15.

In the above first modification, the bristles 32a of the elastic deformation portion 32 are slanted with respect to the thickness direction of the banknote 3. Instead, as needed to adjust the reaction force acting on the banknote 3, the bristles 32a of the elastic deformation portion 32 may be extended from each end surface in the width direction (the Y-direction) of the insertion slot 15 along the width direction. In this configuration, the corrective member 31 may be disposed at each end surface in the width direction of the insertion slot 15. Each of the bristles 32a and 32b of the elastic deformation portion 32 may be arcuately curved in the direction in which the bristles 32a and 32b extend, with the intention to adjust the elasticity.

The corrective member 31 of the first modification has the elastic deformation portion 32 with slanted bristles 32a. The slanted bristles 32a can increase the reaction force acting on the banknote 3 and therefore improve the corrective action to move the banknote 3 in the width direction (the Y-direction) of the insertion slot 15.

### Second Modification

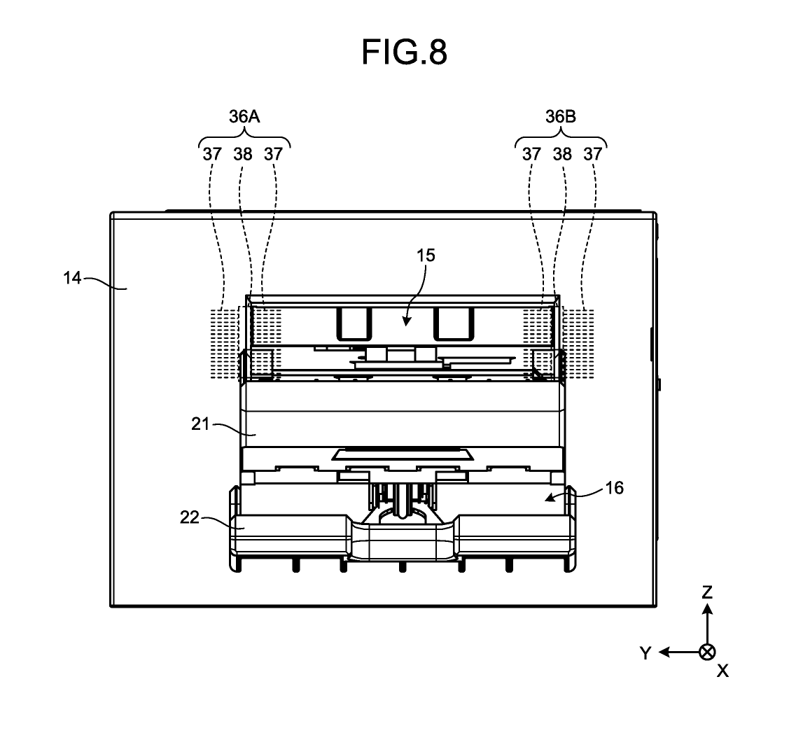

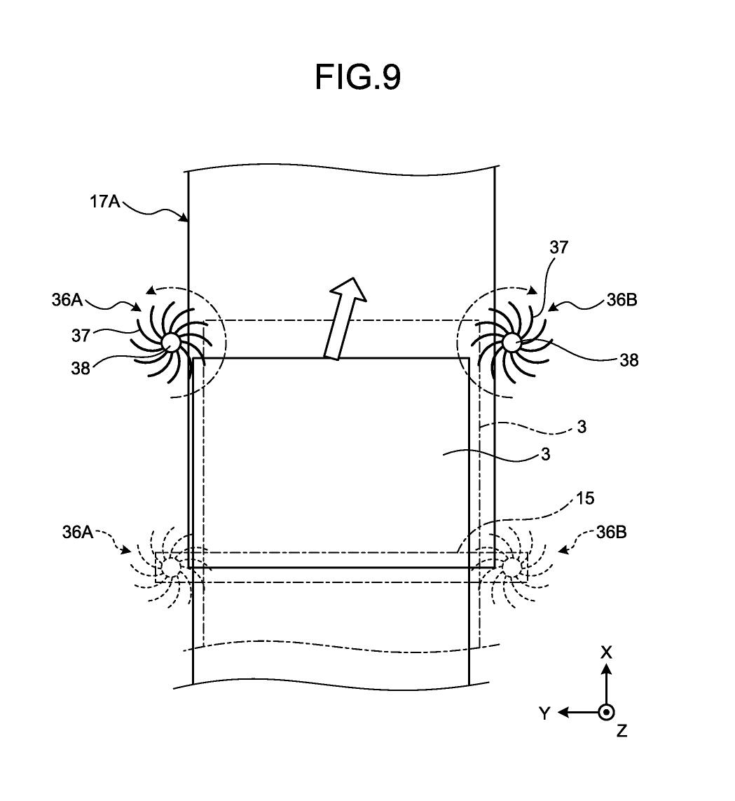

FIG. 8 is a front view to explain a corrective member of a second modification. FIG. 9 is another front view to explain the corrective member of the second modification. The second modification is different from the embodiment in that an elastic deformation portion of a corrective member is rotatable.

As illustrated in FIG. 8 and FIG. 9, corrective members 36 (36A, 36B) of the second modification are disposed on the deposit conveyor line 17A to convey the banknote 3 inserted through the insertion slot 15, at positions facing both ends in the width direction (the Y-direction) of the insertion slot 15. The corrective member 36 is disposed in front of the conveyor belt 24 of the deposit conveyor line 17A and has an elastic deformation portion 37 correcting the direction of the banknote 3 before the banknote 3 is inserted between the conveyor belt 24 and the pressing plate 28.

The corrective member 36 has a rotational shaft 38 that rotatably supports the elastic deformation portion 37. The elastic deformation portion 37 is radially formed around the rotational shaft 38. The rotational shaft 38 is formed along the vertical direction (the Z-direction) of the insertion slot 15, and is rotatably supported by a supporting member (not illustrated) of the deposit conveyor line 17A. The elastic deformation portion 37 has brush-like bristles. The corrective member 36 is formed as an impeller having the rotational shaft 38 as its center with the bristles of the elastic deformation portion 37 curved around the rotational shaft 38. The bristles of the elastic deformation portion 37 may be straight instead of being curved.

When the banknote 3 inserted through the insertion slot 15 contacts the elastic deformation portion 37 of the corrective member 36 (36A) disposed at an end (the left side in FIG. 9) in the width direction of the insertion slot 15, bristles of the elastic deformation portion 37 rotate counterclockwise in FIG. 9 around the rotational shaft 38. Likewise, when the banknote 3 inserted through the insertion slot 15 contacts the elastic deformation portion 37 of the corrective member 36 (36B) disposed at the opposite end (the right side in FIG. 9) in the width direction of the insertion slot 15, bristles of the elastic deformation portion 37 rotate clockwise in FIG. 9 around the rotational shaft 38. The reaction force of the rotating elastic deformation portion 37 acts on the banknote 3, which allows the corrective member 36 to correct the position and the direction of the banknote 3.

As described above, the corrective members 36 of the second modification are disposed at positions facing both ends in the width direction (the Y-direction) of the insertion slot 15, on the deposit conveyor line 17A to convey the banknote 3 inserted through the insertion slot 15. In the second modification as well as the embodiment, a banknote inserted through the insertion slot 15 receives reaction force upon contact with the elastic deformation portion 37 of the corrective member 36, and the reaction force acts to correct the position and the direction of the banknote 3. In this manner, the banknote 3 can be properly conveyed along the direction of conveyance.

In the second modification, the corrective members 36 rotatably supporting the elastic deformation portion 37 are disposed on the deposit conveyor line 17A. Instead of this layout, as indicated by the broken line in FIG. 8, the corrective members 36 may be disposed at both ends in the width direction of the insertion slot 15. This layout exerts the same effect as that of the second modification. The corrective members 36 may be disposed at both ends in the width direction of the insertion slot 15 and at respective positions facing the corrective members 36 disposed at the ends, on the deposit conveyor line 17A. This layout can enhance the effect of properly conveying the banknote 3 along the direction of conveyance.

### Third Modification

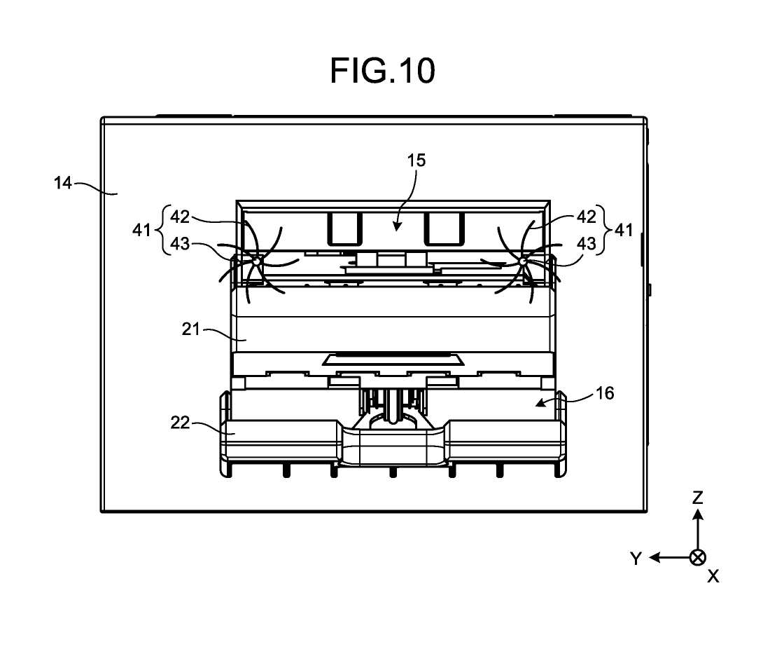

FIG. 10 is a front view to explain a corrective member of a third modification. The third modification is different from the second modification in the location of a corrective member and a direction in which an elastic deformation portion of the corrective member can rotate.

As illustrated in FIG. 10, corrective members 41 of the third modification are disposed at positions facing both ends in the width direction (the Y-direction) of the insertion slot 15. The corrective member 41 has a rotational shaft 43 rotatably supporting an elastic deformation portion 42, and the elastic deformation portion 42 is radially formed around the rotational shaft 43. The rotational shaft 43 is provided along the insertion direction (the X-direction) of the banknote 3 inserted to the insertion slot 15 and is rotatably supported by a supporting member (not illustrated) disposed close to the insertion slot 15. The elastic deformation portion 42 of the corrective member 41 contacts the banknote 3 inserted to the insertion slot 15, which generates reaction force acting on the banknote 3. The reaction force acts to correct the position and the direction of the banknote 3. The direction of the rotational shaft 43 of the elastic deformation portion 42 is not limited to a direction along the X-direction or a direction along the Z-direction as the above second modification. The rotational shaft 43 may be inclined with respect to the X-direction or the Z-direction. The elastic deformation portion 42 is rotated from top to bottom in this embodiment. Instead, the elastic deformation portion 42 may be rotated from bottom to top.

The banknote 3 inserted through the insertion slot 15 receives reaction force upon contact with the elastic deformation portion 42 of the corrective member 41, and the reaction force acts to correct the position and the direction of the banknote 3. Use of the corrective member 41 of the third modification therefore allows the banknote 3 to be properly conveyed along the conveyance direction, as with the second modification.

### Fourth Modification

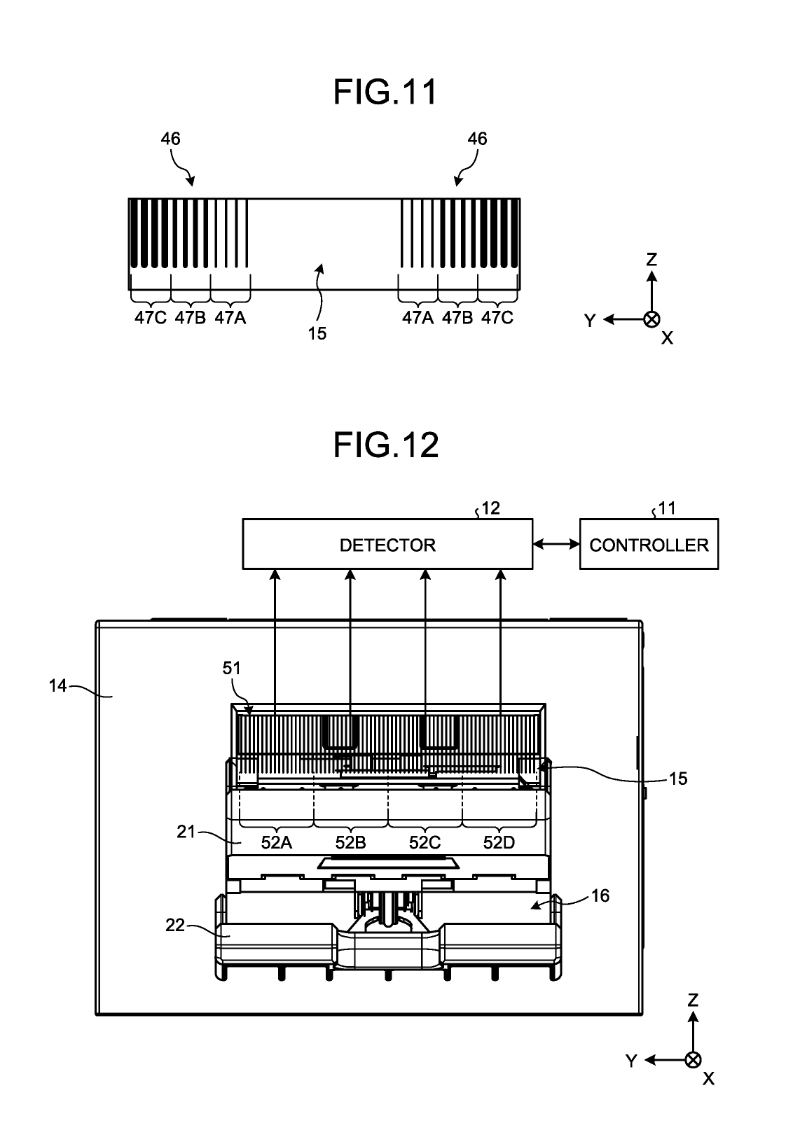

FIG. 11 is a schematic front view of a corrective member of a fourth modification. The fourth modification is different from the embodiment in including a plurality of types of elastic deformation portions different from one another in elasticity.

As illustrated in FIG. 11, corrective members 46 of the fourth modification are disposed on both sides in the width direction (the Y-direction) of the insertion slot 15, and each include a plurality of types of elastic deformation portions 47A, 47B, and 47C, different from one another in elasticity. The elastic deformation portions 47A, 47B, and 47C of the corrective member 46 are arranged along the width direction of the insertion slot 15 such that the elasticity is increased toward the elastic deformation portion 47C located closer to the ends from the elastic deformation portion 47A located closer to the center, in the width direction.

The elastic deformation portions 47A, 47B, and 47C have, for example, respective types of bristles different in thickness (diameter) and thus different in elasticity. In the fourth modification, as an embodiment, brushes with bristles different in diameter are used. Instead, the brush may be made from materials different in elastic modulus.

In the fourth modification described above, the elasticity of the elastic deformation portions 47A, 47B, and 47C becomes greater toward the ends in the width direction of the insertion slot 15. The banknote 3 receives greater reaction force from the elastic deformation portions 47A, 47B, and 47C with an increase in the amount of shift of the banknote 3 inserted to the insertion slot 15 or an increase in the amount of slant of the insertion direction of the banknote 3 with respect to the conveyance direction. The reaction force acting on the banknote 3 is changed with changes in the amount of shift of the banknote 3 and in the amount of slant of the insertion direction of the banknote 3, which can further properly correct the position and the direction of the banknote 3 and thus allows the banknote 3 to be further properly conveyed along the direction of conveyance.

### Fifth Modification

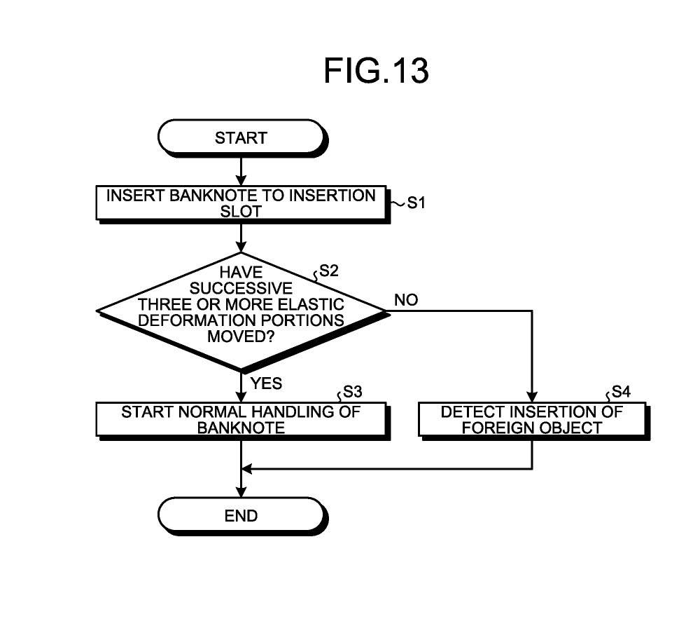

FIG. 12 is a front view of a banknote handling apparatus of a fifth embodiment. FIG. 13 is a flowchart to explain processing of detecting foreign bodies performed by the banknote handling apparatus of the fifth modification. The fifth modification is different from the embodiment in detecting a foreign object inserted to an insertion slot.

As illustrated in FIG. 12, a corrective member 51 of the fifth modification includes fourth elastic deformation portions 52A, 52B, 52C, and 52D provided over the length in the width direction (the Y-direction) of the insertion slot 15. The elastic deformation portions 52A, 52B, 52C, and 52D are continuous with one another in the width direction of the insertion slot 15. The elastic deformation portions 52A, 52B, 52C, and 52D of the corrective member 51 are formed of films (paper sheets). The film is cut in stripes from the front end to contact the banknote 3 toward the upper part of the insertion slot 15 (in the Z-direction).

As illustrated in FIG. 12, the banknote handling apparatus of the fifth modification further includes a detector 12 to detect move (contact with the banknote 3) of the elastic deformation portions 52A, 52B, 52C, and 52D of the corrective member 51. The detector 12 is connected with each of the elastic deformation portions 52A, 52B, 52C, and 52D of the corrective member 51 and connected with the controller 11. The detector 12 detects the range of move of each of the elastic deformation portions 52A, 52B, 52C, and 52D in the width direction of the insertion slot 15. Examples of the detector 12 include a displacement sensor and a vibration sensor. The controller 11 determines whether a foreign object other than the banknote 3 has been inserted to the insertion slot 15, based on a detection signal from the detector 12. The foreign object is a small object such as a coin and a money clip.

The elastic deformation portions 52A, 52B, 52C, and 52D of the corrective member 51 are continuously arranged in the width direction (the Y-direction) of the insertion slot 15. Instead of this layout, for example, these elastic deformation portions may be arranged at certain intervals each smaller than the size of a foreign object detected by the detector 12, in the width direction. As with other embodiments, in the fifth modification, brushes with bristles may be used for the elastic deformation portions 52A, 52B, 52C, and 52D instead of films.

### Method for Detecting Foreign Object

A method for detecting a foreign object in the fifth modification will now be described. When the banknote 3 inserted through the insertion slot 15 is conveyed by the deposit and withdrawal mechanism 17 as a conveyor mechanism, the corrective member 51, which corrects the conveyance direction of the banknote 3 using the elasticity of the elastic deformation portions 52A, 52B, 52C, and 52D contacting the banknote 3, is moved by the banknote 3 inserted to the insertion slot 15. In the method for detecting a foreign object, the detector 12 detects the range of move of the elastic deformation portions 52A, 52B, 52C, and 52D in the width direction (the Y-direction) of the insertion slot 15 along a face of the banknote 3 inserted to the insertion slot 15, and, based on the results detected by the detector 12, the controller 11 determines whether a foreign object other than the banknote 3 has been inserted to the insertion slot 15.

More specifically, for example, as illustrated in FIG. 13, the banknote 3 (or a foreign object) is inserted to the insertion slot 15 (Step S1). Insertion of the banknote 3 to the insertion slot 15 moves any of the elastic deformation portions 52A, 52B, 52C, and 52D of the corrective member 51, and the detector 12 detects the move of the elastic deformation portions 52A, 52B, 52C, and 52D. The controller 11 determines whether successive three or more elastic deformation portions 52 (52A, 52B, 52C, and 52D), among the elastic deformation portions 52A, 52B, 52C, and 52D continuously arranged in the width direction (the Y-direction) of the insertion slot 15, have moved (Step S2).

At Step S2, for move of successive three or more elastic deformation portions 52 (52A, 52B, 52C, and 52D), among four elastic deformation portions 52A, 52B, 52C, and 52D, the controller 11 determines that the banknote 3 has been inserted to the insertion slot 15 and starts a normal handling operation of the banknote 3 with the deposit and withdrawal mechanism 17 conveying the banknote 3 from the insertion slot 15 along the deposit conveyor line 17A (Step S3). At Step S2, for move of successive two elastic deformation portions 52 or only one elastic deformation portion 52 among four elastic deformation portions 52A, 52B, 52C, and 52D, the controller 11 determines that not the banknote 3 but any foreign object smaller than the banknote 3, such as a coin, has been inserted to the insertion slot 15 and detects insertion of the foreign object into the insertion slot 15 (Step S4).

Upon detection of a foreign object, for example, the controller 11 controls the deposit and withdrawal mechanism 17 to stop driving and keeps the foreign object from entering the apparatus through the insertion slot 15. In another manner, upon detection of insertion of a foreign object, the controller 11 may notify the user of insertion of the foreign object by, for example, raising an alert sound or displaying a warning on a display panel or the like of the deposit and withdrawal unit 5.

In the fifth modification described above, the detector 12 detects the range of a continuous move made by the elastic deformation portions 52A, 52B, 52C, and 52D of the corrective member 51, and based on the results detected by the detector 12, the controller 11 can detect insertion of a foreign object. This manner can avoid a breakdown of the deposit and withdrawal mechanism 17 due to intrusion of a foreign object from the insertion slot 15.

The controller 11 detects a foreign object entering alone without the banknote 3. In addition to this function, the controller 11 may determine that a foreign object has entered together with the banknote 3, when the controller 11 detects move of three or more elastic deformation portions 52A, 52B, 52C, and 52D and detects that the amount of move made by the elastic deformation portions 52A, 52B, 52C, and 52D is locally large in the width direction of the insertion slot 15. In the fifth modification, for example, as with the second modification, the corrective member 36 may be disposed on the deposit conveyor line 17A. The corrective member 36 on the deposit conveyor line 17A can properly correct the position and the direction of the banknote 3, and thus can reduce jams of the banknote 3.

The banknote handling apparatus in the embodiment and the modifications can further effectively reduce jams of the banknote 3 in use under such environments or countries that have a comparatively wide variety of kinds of the banknote 3 different from one another in size.

According to an aspect of the paper sheet handling apparatus described in the present invention, paper sheets inserted through an insertion slot can be properly conveyed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A paper sheet handling apparatus, comprising:
an insertion slot to which a paper sheet is inserted;
a conveyor mechanism that conveys the paper sheet inserted through the insertion slot; and
a corrective member which includes an elastic deformation portion configured to contact the paper sheet inserted to the insertion slot and which corrects a direction of conveyance of the paper sheet inserted through the insertion slot using elasticity of the elastic deformation portion, wherein
the corrective member is disposed at least on both ends in a width direction of the insertion slot, along a face of the paper sheet inserted to the insertion slot, or at positions, on a conveyor line for the paper sheet inserted through the insertion slot, facing the ends in the width direction of the insertion slot.

2. The paper sheet handling apparatus according to claim 1, wherein the elastic deformation portion extends in a slant manner toward a conveyor line for the paper sheet inserted through the insertion slot with respect to an opening surface of the insertion slot.

3. The paper sheet handling apparatus according to claim 1, wherein
the corrective member is disposed at both the ends in the width direction of the insertion slot, and
the elastic deformation portion extends in a slant manner toward a center of the insertion slot in the width direction with respect to a thickness direction of the paper sheet inserted to the insertion slot, on an opening surface of the insertion slot.

4. The paper sheet handling apparatus according to claim 1, wherein
the corrective member includes a plurality of types of the elastic deformation portions different from one another in elasticity, and
the types of the elastic deformation portions are arranged along the width direction of the insertion slot such that elasticity is increased toward both ends from a center of the insertion slot in the width direction.

5. The paper sheet handling apparatus according to claim 1, wherein the corrective member has a rotational shaft that rotatably supports the elastic deformation portion, and the elastic deformation portion is radially formed around the rotational shaft.

6. The paper sheet handling apparatus according to claim 1, wherein
the corrective member is arranged along the width direction of the insertion slot,
the paper sheet handling apparatus further comprising:
a detector that detects a range of move of the elastic deformation portion of the corrective member in the width direction of the insertion slot; and
a controller that is configured to determine that a foreign object other than the paper sheet has been inserted to the insertion slot, based on a result detected by the detector.

7. The paper sheet handling apparatus according to claim 1, wherein the elastic deformation portion of the corrective member is a brush or a film.

8. A method for detecting a foreign object, the method comprising:
in conveyance of a paper sheet inserted through an insertion slot with a conveyor mechanism, having a corrective member to correct a direction of conveyance of the paper sheet using elasticity of an elastic deformation portion contacting the paper sheet, moved by the paper sheet inserted to the insertion slot;
with a detector, detecting a range of move of the elastic deformation portion in a width direction of the insertion slot, along a face of the paper sheet inserted to the insertion slot, and
with a controller, determining that a foreign object other than the paper sheet has been inserted to the insertion slot, based on a result detected by the detector.
